(19) United States
(12) Patent Application Publication
(10) Pub. No.: US 2007/0262167 A1
(43) Pub. Date: Nov. 15, 2007

(54) Disposable syringe

(76) Inventor: Charlie Cheng, Taichung City (TW)

Correspondence Address: COURTNEY STANIFORD & GREGORY LLP, P.O. BOX 9686, SAN JOSE, CA, 95157, US

(21) Appl. No.: 11/413,484

(22) Filed: Apr. 28, 2006

(51) Int. Cl. F02M 47/02

(52) U.S. Cl. 239/89; 239/88

(57) ABSTRACT

A disposable syringe includes a barrel, a needle unit, and a plunger. The barrel includes a larger-cross-section passage and a smaller-cross-section passage. The needle unit includes a needle seat fitted sealingly in the smaller-cross-section passage, and a needle fixed to the needle seat and extending outwardly and forwardly of the needle seat. The needle seat has an inner wall surface and an interior flange protruding inwardly from the inner wall surface. The plunger is slidable in the larger-cross-section passage, and includes a front piston and an anchoring member fixed to the front piston. The anchoring member is extendable into the needle seat, and is deformable to pass through the interior flange so as to move toward the needle. The anchoring member has a hole whose size is variable to permit the anchoring member to deform.

### BACKGROUND OF THE INVENTION

1. Field of the Invention

The invention relates to a disposable syringe, more particularly to a disposable syringe in which a needle unit can be retracted within a barrel after use to ensure safety and to facilitate disposal.

2. Description of the Related Art

Referring to FIG. 1, a conventional syringe 9 includes a barrel 91, a plunger 92, a needle seat 93, and a needle 94. The barrel 91 includes a larger-diameter segment 913 confining a larger-cross-section passage 911, a smaller-diameter segment 914 confining a smaller-cross-section passage 912, and a shoulder portion 915 between the larger-diameter segment 913 and the smaller-diameter segment 914. The plunger 92 is slidable in the larger-cross-section passage 911 of the barrel 91. The needle seat 93 is fitted sealingly in the smaller-cross-section passage 912 of the barrel 91, and includes a surrounding wall 933 confining a needle fixing hole 931 and a channel section 932. The needle 94 includes a fixing portion 941 fixed in the needle fixing hole 931 of the needle seat 93, and a puncturing portion 942 extending out of the needle seat 93.

Since forward movement of the plunger 92 is stopped by the shoulder portion 915, some medicine or blood may remain within the channel section 932 or within the smaller-cross-section passage 912, which may cause contamination to the personnel who is accidentally pricked by the needle 94.

In order to overcome the aforesaid disadvantage, various disposable syringes were developed in the art. However, the mechanisms of the conventional disposable syringes are relatively complex, and the assembly and operations thereof are relatively difficult. Moreover, the problem of medicine or blood remaining in the barrel or the needle seat is not solved satisfactorily.

### SUMMARY OF THE INVENTION

Therefore, the object of this invention is to provide a disposable syringe in which a needle unit can be retracted within a barrel after use to ensure safety and to facilitate disposal, and in which the problem of medicine or blood remaining in the barrel or the needle unit can be overcome.

The disposable syringe according to this invention includes a barrel, a needle unit, and a plunger. The barrel includes a larger-cross-section passage and a smaller-cross-section passage. The needle unit includes a needle seat fitted sealingly in the smaller-cross-section passage, and a needle fixed to the needle seat and extending outwardly and forwardly of the needle seat. The needle seat has an inner wall surface and an interior flange protruding inwardly from the inner wall surface. The plunger is slidable in the larger-cross-section passage, and includes a front piston and an anchoring member fixed to the front piston. The anchoring member is extendable into the needle seat, and is deformable to pass through the interior flange so as to move toward the needle. The anchoring member has a hole whose size is variable to permit the anchoring member to deform.

### BRIEF DESCRIPTION OF THE DRAWINGS

Other features and advantages of the present invention will become apparent in the following detailed description of the preferred embodiment with reference to the accompanying drawings, of which:

FIG. 1 is a sectional view of a conventional syringe;

FIG. 2 is an exploded partly sectional view of the preferred embodiment of the disposable syringe according to this invention; and

FIGS. 3, 4, 5 and 6 are sectional views to illustrate the preferred embodiment in various stages of use.

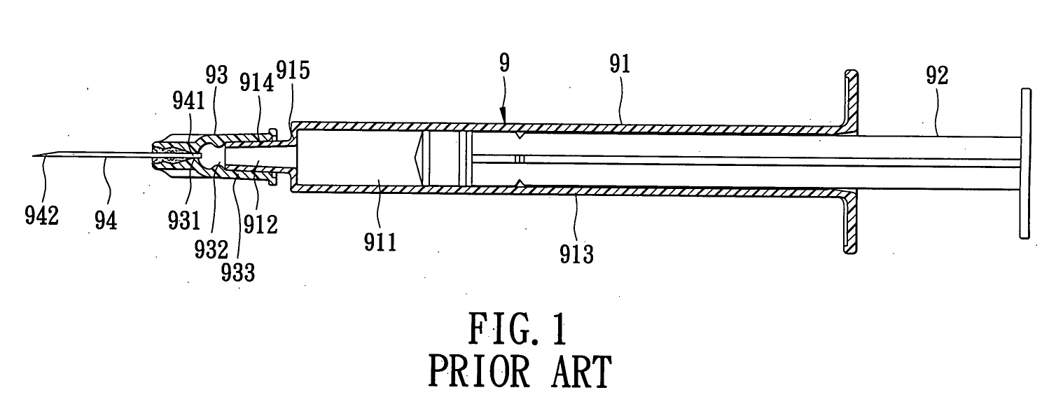

### DETAILED DESCRIPTION OF THE PREFERRED EMBODIMENT

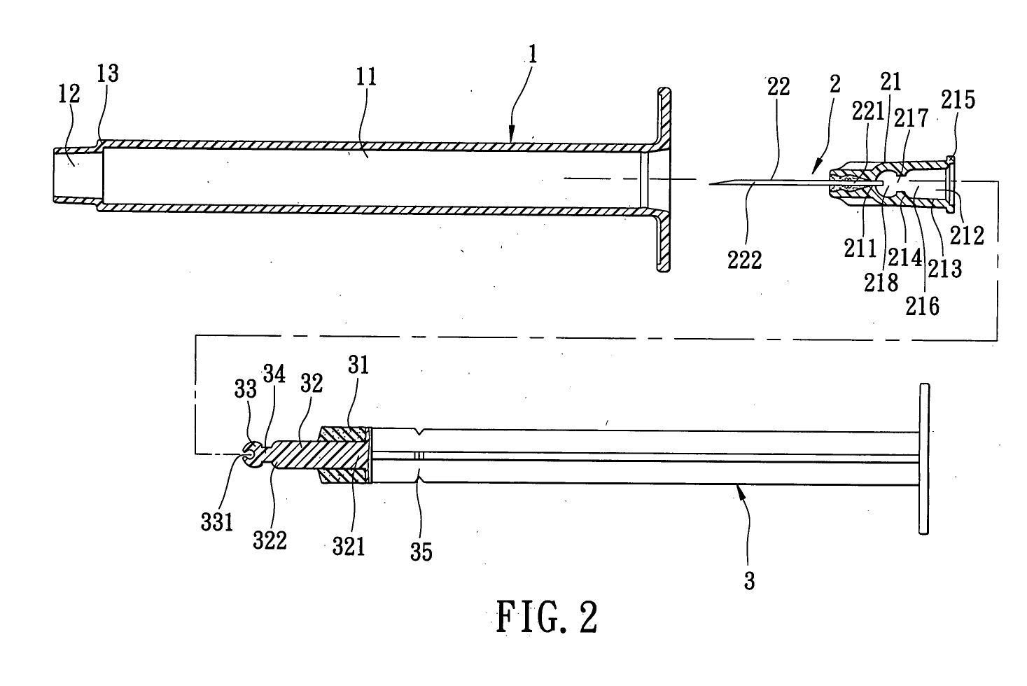

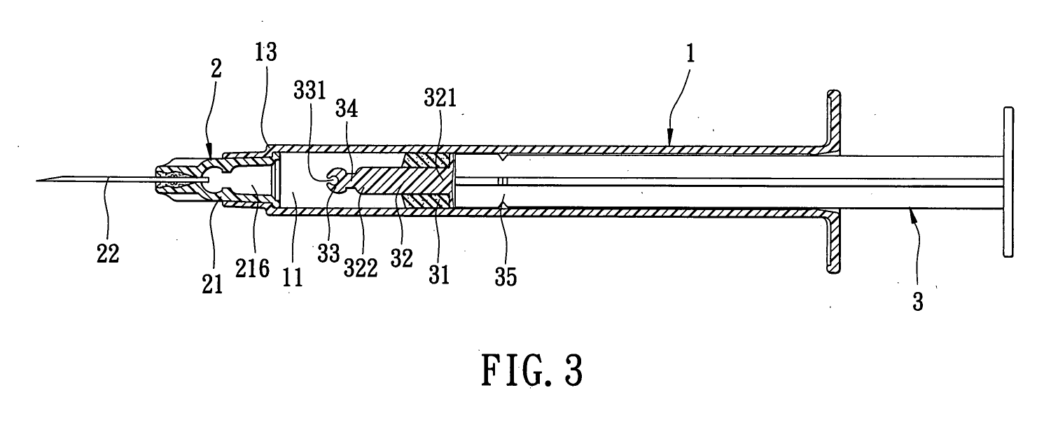

Referring to FIGS. 2 and 3, the preferred embodiment of a disposable syringe according to this invention is shown to include a barrel 1, a needle unit 2, and a plunger 3.

The barrel 1 includes a larger-cross-section passage 11, a smaller-cross-section passage 12, and a shoulder portion 13 between the larger-cross-section passage 11 and the smaller-cross-section passage 12.

The needle unit 2 includes a needle seat 21 and a needle 22. The needle seat 21 is inserted into the barrel 1 via the larger-cross-section passage 11 and is fitted sealingly in the smaller-cross-section passage 12. The needle 22 is fixed to the needle seat 21 and extends outwardly and forwardly of the needle seat 21. The needle seat 21 has an inner wall surface 213 and an interior flange 214 protruding inwardly from the inner wall surface 213. The needle seat 21 further includes a front needle fixing hole 211 to fix the needle 22, a rear flange 215 projecting outwardly from a rear end of the needle seat 21 and abutting against the shoulder portion 13 of the barrel 1, and a channel 216 formed between the front needle fixing hole 211 and the rear flange 215 and surrounded by the inner wall surface 213. The interior flange 214 protrudes into the channel 216 from the inner wall surface 213. The channel. 216 has a neck section 217 defined by the interior flange 214, a front channel section 218 between the needle fixing hole 211 and the neck section 217, and a rear channel section 212 between the neck section 217 and the rear flange 215. The needle 22 includes a fixing portion 221 fixed in the front needle fixing hole 211 of the needle seat 21, and a puncturing portion 222 extending out of the needle seat 21.

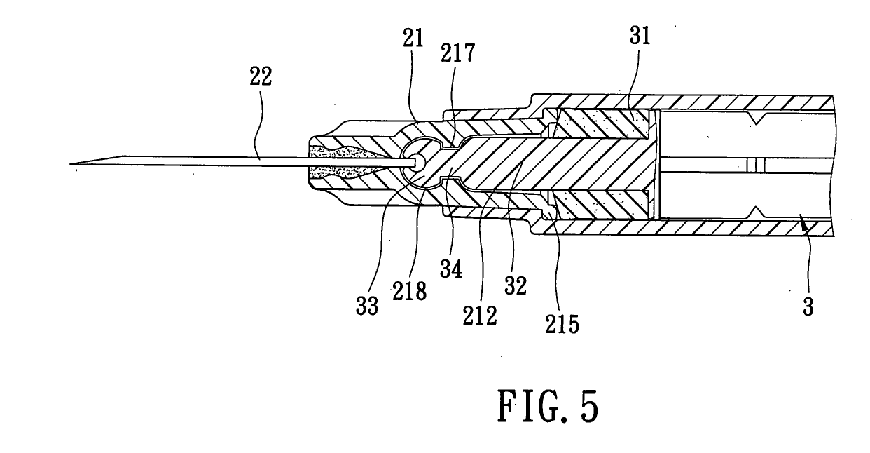

The plunger 3 is slidable in the larger-cross-section passage 11 of the barrel 1, and includes a front piston 31 and an anchoring member 33 fixed to the front piston 31. The anchoring member 33 is extendable into the needle seat 21, and is deformable to pass through the interior flange 214 so as to move toward the needle 22. The anchoring member 33 has a hole 331 whose size is variable to permit the anchoring member 33 to deform. Preferably, the plunger 3 further includes a shaft 32 that has a rear end 321 connected to the front piston 31, and a front end 322 connected to the anchoring member 33. In this embodiment, the plunger 3 further has a constricted part 34 connected between the anchoring member 33 and the front end 322 of the shaft 32. The anchoring member 33, the constricted part 34, and the shaft 32 are sized to substantially fill spaces of the front channel section 218, the neck section 217, and the rear channel section 212, respectively, when the anchoring member 33 is moved to the needle 22, as best shown in FIG. 5.

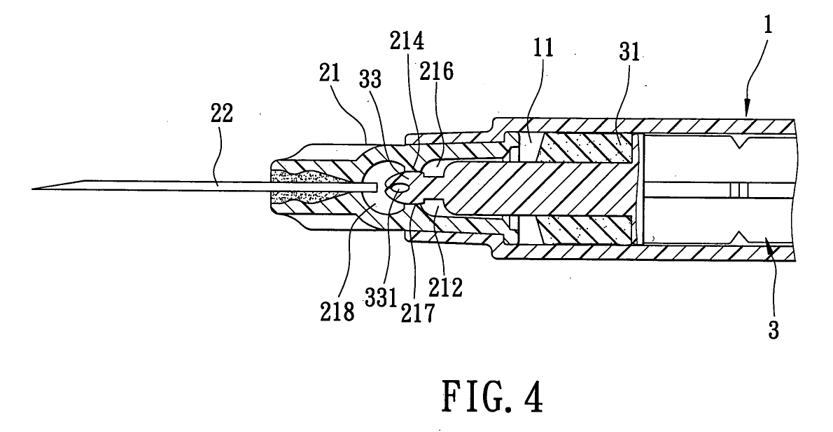

Referring to FIGS. 3 and 4, in use, the plunger 3 is pressed forwardly along the larger-cross-section passage 11 of the barrel 1 to push the piston 31 of the plunger 3 toward the needle seat 21. The drug solution in the barrel 1 can almost be completely injected via the larger-cross-section passage 11 of the barrel 1, the channel 216 of the needle seat 21, and the needle 22.

Referring to FIGS. 4 and 5, when the piston 31 of the plunger 3 is further pushed toward the needle seat 21, the size of the hole 331 of the anchoring member 33 is varied to permit the anchoring member 33 to deform. The anchoring member 33 can thus pass through the interior flange 214 of the needle seat 21 and is extended into the front channel section 218 of the channel 216. Therefore, the anchoring member 33, the constricted part 34, and the shaft 32 substantially fill the spaces of the front channel section 218, the neck section 217, and the rear channel section 212, respectively, when the piston 31 of the plunger 3 abuts against the rear flange 215 of the needle seat 21. Any residual drug solution in the channel 216 of the needle seat 21 can almost be completely injected via the needle 22.

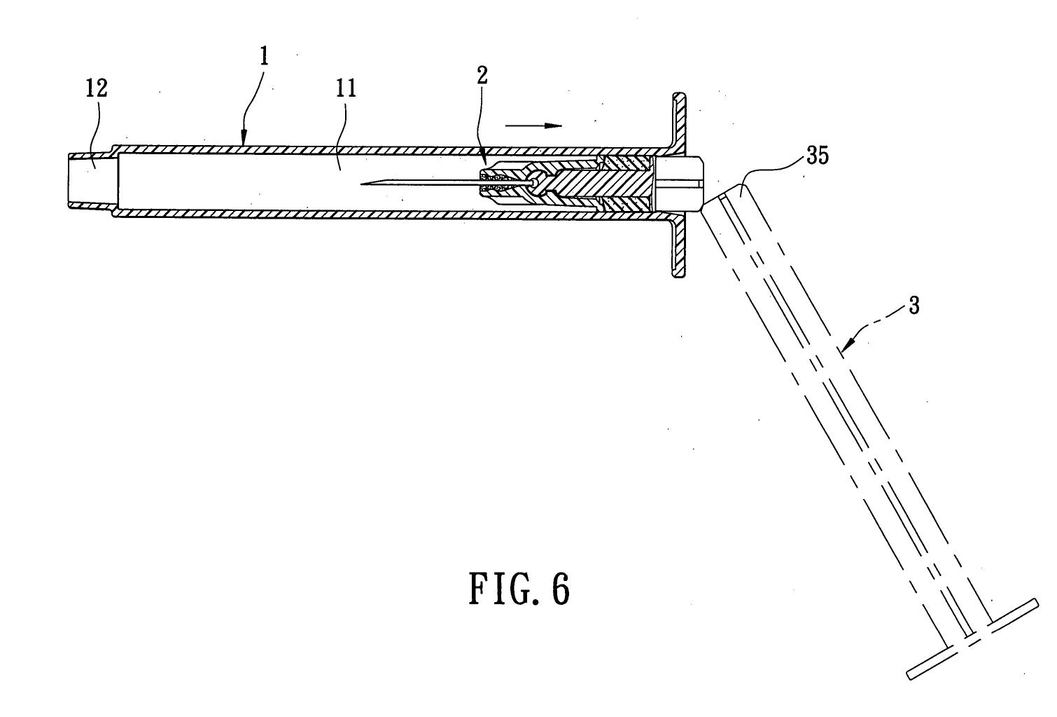

Referring to FIG. 6, after use, the plunger 3 is pulled backward away from the smaller-cross-section passage 12 of the barrel 1 so that the used needle unit 2 is retracted into the larger-cross-section passage 11 of the barrel 1. In this state, the used needle unit 2 can be enclosed in the larger-cross-section passage 11 of the barrel 1 for safe disposal. Thereafter, the plunger 3 can be broken easily at a weakened area 35 for convenient disposal.

In view of the aforesaid, the disposable syringe of this invention has the following advantages:

1. Since the used needle unit 2 can be enclosed in the larger-cross-section passage 11 of the barrel 1, the chances that the personnel handling the syringe may be accidentally pricked or pierced by the needle 22 are substantially reduced. The safety in use and disposal is thus enhanced.

2. Since the needle seat 21 is fitted sealingly in the smaller-cross-section passage 12 of the barrel 1, and since the anchoring member 33, the constricted part 34, and the shaft 32 substantially fill the spaces of the front channel section 218, the neck section 217, and the rear channel section 212, respectively, when the piston 31 of the plunger 3 abuts against the rear flange 215 of the needle seat 21, any residual drug solution in the channel 216 of the needle seat 21 can almost be completely injected via the needle 22.

3. Since the mechanism of the needle unit 2 is relatively simple, the anchoring member 33 can be extended and positioned in the front channel section 218 by deforming. The assembly and the operation of the syringe of this invention are relatively easy.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

I claim:

1. A disposable syringe, comprising:
a barrel including a larger-cross-section passage and a smaller-cross-section passage;
a needle unit including a needle seat fitted sealingly in said smaller-cross-section passage, and a needle fixed to said needle seat and extending outwardly-and forwardly of said needle seat, said needle seat having an inner wall surface and an interior flange protruding inwardly from said inner wall surface; and
a plunger slidable in said larger-cross-section passage, and including a front piston and an anchoring member fixed to said front piston, said anchoring member being extendable into said needle seat and being deformable to pass through said interior flange so as to move toward said needle, said anchoring member having a hole whose size is variable to permit said anchoring member to deform.

2. The disposable syringe as claimed in claim 1, wherein said plunger further includes a shaft that has a rear end connected to said front piston, and a front end connected to said anchoring member.

3. The disposable syringe as claimed in claim 2, wherein said needle seat further includes a front needle fixing hole to fix said needle, a rear flange projecting outwardly from a rear end of said needle seat, and a channel formed between said front needle fixing hole and said rear flange and surrounded by said inner wall surface, said interior flange protruding into said channel from said inner wall surface, said channel having a neck section defined by said interior flange, a front channel section between said needle fixing hole and said neck section, and a rear channel section between said neck section and said rear flange.

4. The disposable syringe as claimed in claim 3, wherein said plunger further has a constricted part connected between said anchoring member and said shaft, said anchoring member, said constricted part, and said shaft being sized to substantially fill spaces of said front channel section, said neck section, and said rear channel section, respectively, when said anchoring member is moved to said needle.
